(19) United States
(12) Patent Application Publication
(10) Pub. No.: US 2004/0239608 A1
(43) Pub. Date: Dec. 2, 2004

(54) Shift register and liquid crystal display having the same

(76) Inventor: Woo-Suk Chung, Dongan-gu (KR)

Correspondence Address: CANTOR COLBURN, LLP, 55 GRIFFIN ROAD SOUTH, BLOOMFIELD, CT, 06002

(21) Appl. No.: 10/489,589

(22) PCT Filed: Mar. 26, 2002
(86) PCT No.: PCT/KR02/00519

(30) Foreign Application Priority Data
Oct. 16, 2001 (KR) 2001/63800

(51) Int. Cl. G09G 3/36

(52) U.S. Cl. 345/100

(57) ABSTRACT

A shift register where multiple stages are connected in a cascade fashion is disclosed. Each of the multiple stages has an input section for combining a first output signal supplied from the first output terminal of a previous stage and a first output signal of the input section to generate a control signal. A level shift section generates a first pulse signal and a second pulse signal. An output section inverts a phase of the first pulse signal to output the phase-inverted first pulse signal to the first output terminal coupled to the first input terminal of a next stage as the first output signal. The output section inverts a phase of the second pulse signal, outputs the phase-inverted second pulse signal to the second output terminal coupled to the second input terminal of the next stage as the second output signal, and buffers the second pulse signal.

### TECHNICAL FIELD

The present invention relates to a shift register and a liquid crystal display (LCD), and more particularly, to a shift register having an improved circuit capable of decreasing power consumption when it is applied to a gate driver and a data driver of an LCD.

### BACKGROUND ART

Generally, an LCD uses an active matrix driving method in which scanning lines on the screen are sequentially selected and switching elements such as thin film transistors (TFTs) connected to pixels on the selected scanning lines are turned on.

Transmission type TFT-AM LCD is provided with an LCD panel, a driving part, a backlight unit, whereas reflection type TFT-AM LCD is provided with a reflection plate instead of the backlight unit.

In the transmission type TFT-AM LCD, it is well known that the backlight unit consumes a power of an approximately 70% or so, the control part for carrying out a signal processing consumes a power of an approximately 10% or so, and a signal line driving LSI consumes a power of an approximately 10% or so therein. Further, a power of an approximately 4% or so is consumed for the purpose of charging and discharging the signal lines.

In order to lower the power consumption in the LCD, technology developments are actively being progressed toward three ways for high efficiency of the backlight assembly, low power consumption of the driving circuit, and high transmittance of the LCD panel.

For the purpose of low power consumption in the driving circuits, people's attraction is directed toward a polycrystalline silicon (poly-Si) TFT LCD technology from an amorphous silicon (a-Si) TFT LCD technology. Because the poly-Si device has a carrier mobility 100 times or more faster than that of the a-Si device, the switch for the pixel, the gate driving circuits, and the data driving circuits can be integrated on a single glass substrate.

Also, since the poly-Si device allows a substantial reduction of device size in the pixel region due to a high carrier mobility, a penetration voltage badly affecting on the picture quality can be decreased, and even storage capacitance can be decreased, to thereby enhance the aperture ratio.

Further, since the driving circuits can be integrated on the substrate, the process for manufacturing an LCD module is simplified.

As the driving circuit of the poly-Si LCD, a CMOS-LSI is used generally. The driving circuit includes the data driving circuit and the gate driving circuit. Then, since the gate driving circuit has much lower driving frequency than the data driving circuit, the data driving circuit has much higher power consumption than the gate driving circuit.

The data driving circuit is classified into an analog data driving circuit that receives an analog signal as an input and analog-processes the received signal, and a digital data driving circuit that receives a digital signal as an input and converts the received digital signal into an analog signal.

According to a tendency in which an external control circuit is driven at a relatively low voltage, the digital driving circuit includes a level shift type shift register which receives a clock signal having a swing width of 0-3V as an input and generates a scan pulse signal having a swing width of 0-9V.

The level shifter of the shift register generates a level-shifted signal in which a voltage is divided by turn-on resistances of the pull-up transistor and the pull-down transistor. Accordingly, during the level shifting operation, a steady current passing through the pull-up transistor and the pull-down transistor as turned on is formed, and power is consumed during this period.

### DISCLOSURE OF THE INVENTION

Accordingly, the present invention has been devised to solve the foregoing problems of the conventional art, and it is an object of the present invention to provide a shift register operated at a low power and having an improved level shifter structure capable of decreasing the steady current during the level shift operation.

It is another object of the present invention to provide an LCD to which a lower power driving type shift register is applied.

To accomplish the first object, there is provided a shift register in which multiple stages are connected in a cascade fashion, each of the multiple stages including a first input terminal, a second input terminal, a first output terminal, a second output terminal, a third output terminal, a clock input terminal, and an inverted clock input terminal.

Each of the multiple stages includes an input section for combining a first output signal supplied from the first output terminal of a previous stage and a first output signal of the input section to generate a control signal. A level shift section respectively generates a first pulse signal which shifts a level of an inverted clock signal supplied to the inverted clock terminal, and a second pulse signal which shifts a level of a clock signal supplied to the clock terminal in response to the control signal of the input section and a second output signal supplied from the second output terminal of the previous stage. An output section inverts a phase of the first pulse signal and outputting the phase-inverted first pulse signal to the first output terminal coupled to the first input terminal of a next stage as the first output signal. The output section also inverts a phase of the second pulse signal, outputs the phase-inverted second pulse signal to the second output terminal coupled to the second input terminal of the next stage as the second output signal, and buffers the second pulse signal to output the buffered second pulse signal to the third output terminal as a third output signal.

A liquid crystal display of the present invention includes a display cell array circuit, a data driving circuit, and a gate driving circuit respectively formed on a transparent substrate. The display cell array circuit includes multiple data lines and multiple gate lines. The respective display cell array circuits are connected to a pair of gate lines corresponding thereto.

At least either one of the data driving circuit or the gate driving circuit includes a shift register generating a high voltage scan pulse signal synchronized with a low voltage clock signal.

### BRIEF DESCRIPTION OF THE DRAWINGS

The above objects and other advantages of the present invention will become more apparently by describing in detail the preferred embodiments thereof with reference to the accompanying drawings, in which:

FIG. 1 is a simplified plan view showing a TFT substrate in a general poly-TFT LCD;

FIG. 2 is a block diagram of a shift register in accordance with the present invention;

FIG. 3 is a circuit diagram of each of stages of the shift register in accordance with the present invention;

FIGS. 4 and 5 are timing diagrams of respective elements shown in FIG. 3;

FIG. 6 is a circuit diagram of each of stages of the shift register in accordance with another embodiment of the present invention;

FIG. 7 is a comparative example with the shift register shown in FIG. 3, and is a block diagram of the shift register;

FIG. 8 is a circuit diagram of each of the stages of the shift register shown in FIG. 7;

FIGS. 9 and 10 are timing diagrams of respective elements shown in FIG. 8; and

FIG. 11 is a graph showing power consumptions in the shift registers of the present invention and the comparative example.

### BEST MODE FOR CARRYING OUT THE INVENTION

Hereinafter, preferred embodiments are described with reference to the accompanying drawings.

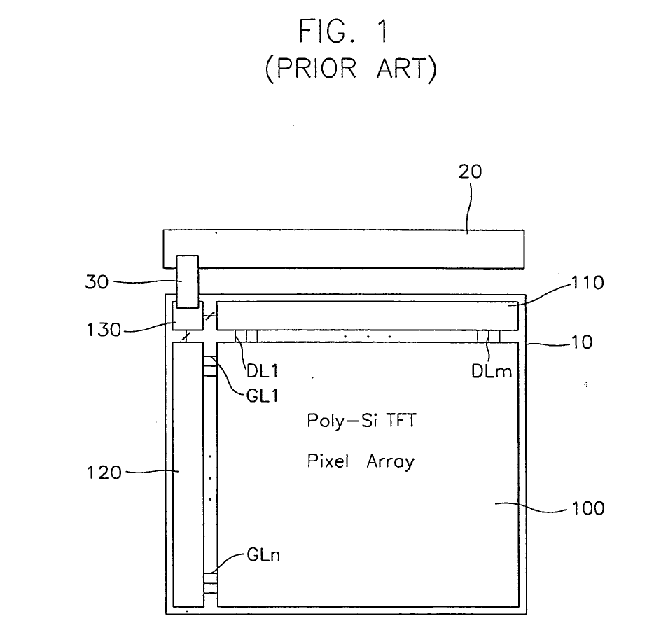

Referring to FIG. 1, an LCD panel generally includes a color filter substrate, a TFT substrate 10, and liquid crystal interposed between the color filter substrate and the TFT substrate 10.

On the TFT substrate 10, there are formed a display cell array circuit 100, a data line driving circuit 110, a gate line driving circuit 120, an external connection terminal 130. The external connection terminal is connected to an external integrated printed circuit board (PCB) 20 through a film cable 30. For the purpose of low power consumption, the external integrated PCB 20 provides clock signal and inverted clock signal having a low voltage, for instance a swing width of 3V, pixel data, control signal and the like to a driving circuit formed on the TFT substrate 10.

The display cell array circuit 100 includes m number of data lines DL1-DLM extended along the column direction, and n number of gate lines GL1-GLn extended along the row direction.

Each of the data line driving circuit 110 and the gate line driving circuit 120 includes a shift register for sequentially generating high voltage scan signals synchronized to an external low voltage clock signal by an external start signal.

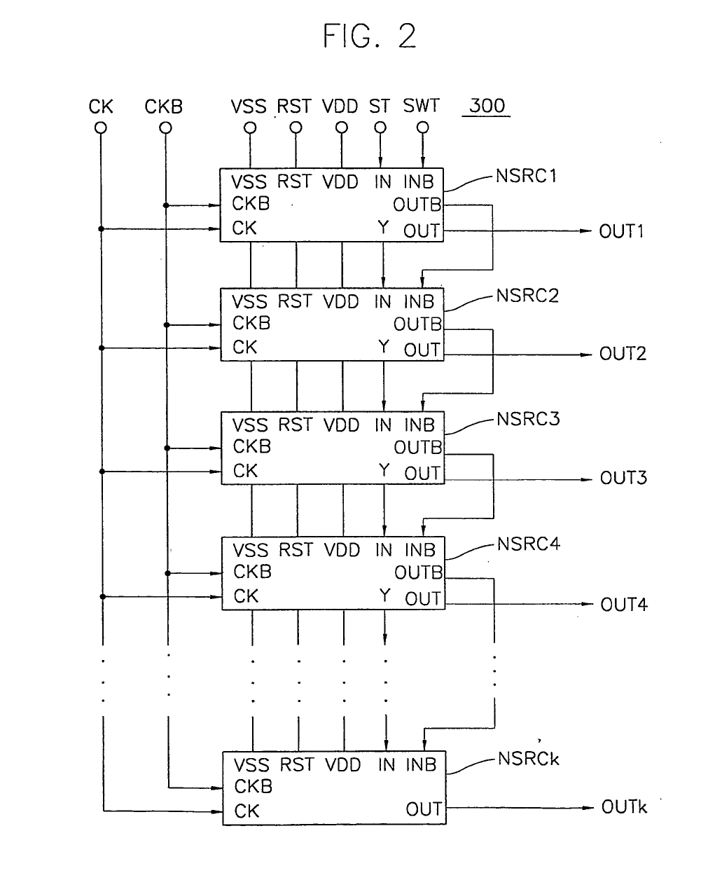

Hereinafter, one preferred embodiment of the present invention is described with reference to FIG. 2 through FIG. 5.

Referring to FIG. 2, an improved shift register 300 of the present invention includes multiple stages NSRC1-NSRCk connected in a cascade fashion.

Each stage includes a first input terminal IN, a second input terminal INB, a clock terminal CK, an inverted clock terminal CKB, a first power voltage terminal VDD, a second power voltage terminal VSS, a first output terminal Y, a second output terminal OUTB, a third output terminal OUT, and a reset terminal RST.

The stages NSRC1-NSRCk are connected in a cascade fashion in which the first output terminal Y and the second output terminal of (i−1)-th stage NSRC(i−1) are connected to the first input terminal IN and the second input terminal INB of (i)-th stage NSRCi, and the first output terminal Y and the second output terminal of (i)-th stage NSRCi are connected to the first input terminal IN and the second input terminal INB of (i+1)-th stage NSRC(i+1). Start signal ST is connected to the input terminal IN of the first stage NSRC1, and start signal STB which is inverted through an inverter INV is connected to the input terminal INB.

A pulse signal output from the third output terminal OUT of each stage is provided as the scan pulse signal.

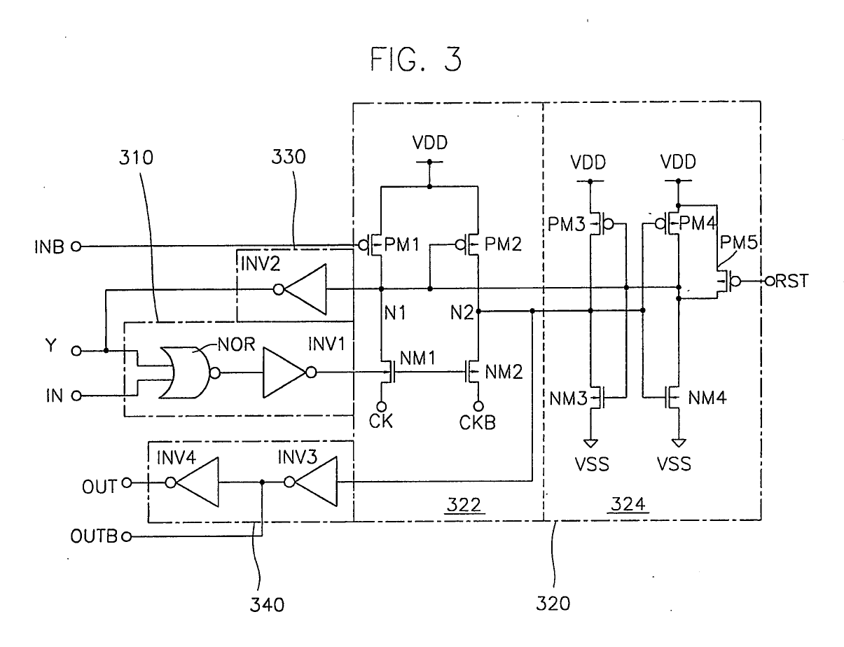

Referring to FIG. 3, each stage of the shift register 300 includes an input circuit 310, a level shifter 320, a first output circuit 330, and a second output circuit 340.

The input circuit 310 includes a NOR gate for combining signals provided from the first input terminal IN and the first output terminal Y thereof to generate a combination signal, and an inverter INV1 for inverting the combination signal to output a control signal.

The level shifter 320 includes a level shift part 322 and a latch part 324.

The level shift part 322 includes first and second PMOS transistors PM1 and PM2, and first and second NMOS transistors NM1 and NM2.

The first PMOS transistor PM1 has a source connected to a first power voltage terminal VDD, a drain connected to a first node N1, and a gate connected to a second input terminal INB. The first NMOS transistor NM1 has a drain connected to the first node N1, a source connected to a clock terminal CK, and a gate connected to the control signal CTL.

The second PMOS transistor PM2 has a source connected to the first power voltage terminal VDD, a drain connected to a second node N2, and a gate connected to the first node N1. The second NMOS transistor NM2 has a drain connected to the second node N2, a source connected to an inverted clock terminal CKB, and a gate connected to the control signal CTL.

In order to minimize the steady current during the level shift, the first and second PMOS transistors PM1 and PM2 are constituted to have a relatively smaller size than the first and second NMOS transistors NM1 and NM2, for instance, approximately ⅕ of the size of the first and second NOS transistors NM1 and NM2.

The latch part 224 includes third to fifth PMOS transistors PM3 to PM5, and third and fourth NMOS transistors NM3 and NM4.

The third PMOS transistor PM3 has a source connected to the first power voltage terminal VDD, a drain connected to the second node N2, and a gate connected to the first node N1. The third NMOS transistor NM3 has a drain connected to the second node N2, a source connected to the second power voltage terminal VSS, and a gate connected to the first node N1.

The fourth PMOS transistor PM4 has a source connected to the first power voltage terminal VDD, a drain connected to the first node N1, and a gate connected to the second node N2. The fourth NMOS transistor NM4 has a drain connected to the first node N1, a source connected to the second power voltage terminal VSS, and a gate connected to the second node N2.

The fifth PMOS transistor PM5 has a source connected to the first power voltage terminal VDD, a drain connected to the first node N1, and a gate connected to the reset terminal RST.

In order to rapidly charge the first and second nodes N1 and N2 and thus to latch an input signal to a stable state, the third to fifth PMOS transistors PM3 to PM5 are constituted to have a size relatively larger than the third and fourth NMOS transistors, for instance, 7-8 times larger.

The first output circuit 330 inverts the signal of the first node N1 through the inverter INV2 and outputs the inverted signal to the first output terminal Y.

The second output circuit 340 includes inverters INV3 and INV4 connected in a cascade fashion, and it allows the inverter INV3 to invert the signal of the second node N2 and output the inverted signal to the second output terminal OUTB, and allows the inverter INV4 to invert the output of the inverter INV3 and output the inverted signal to the third output terminal OUT.

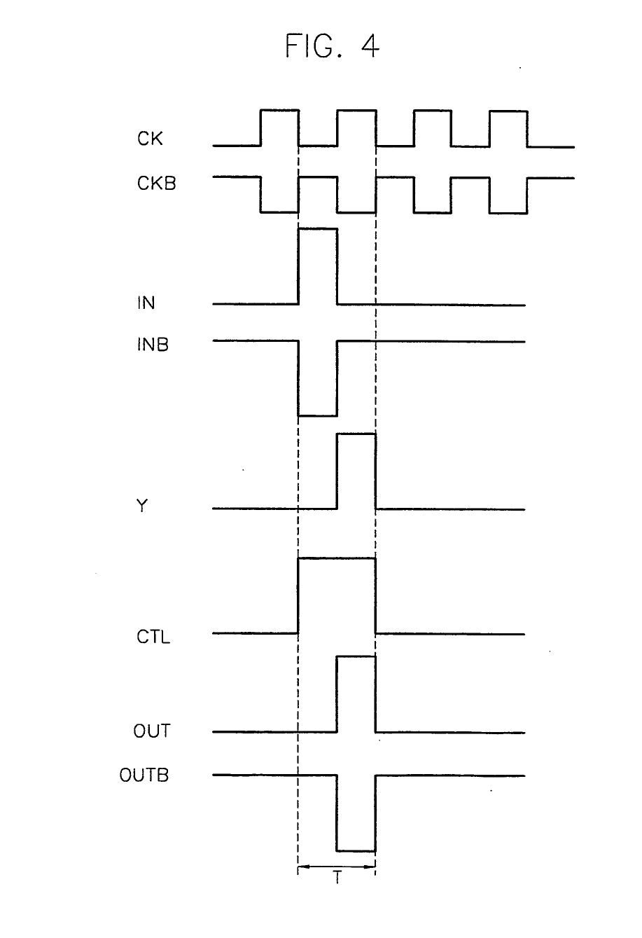

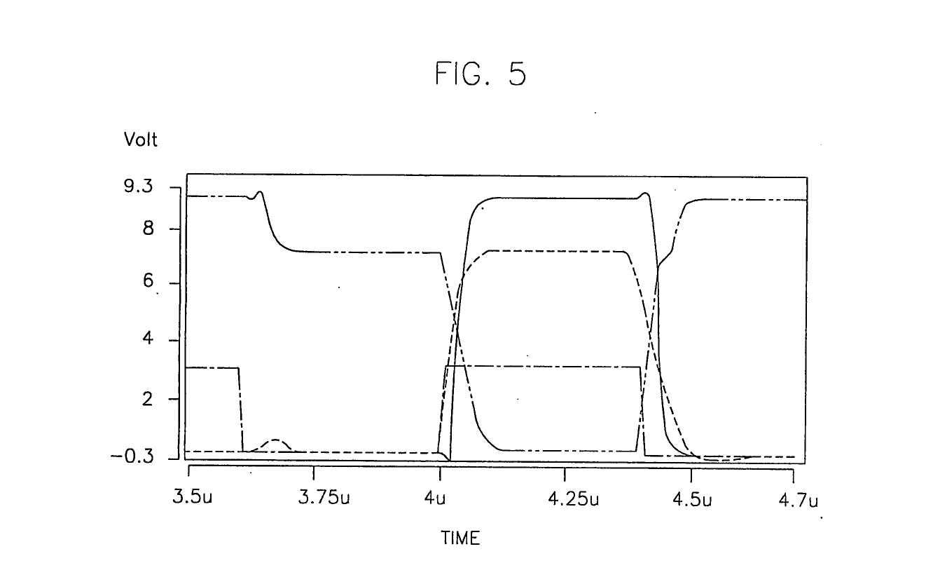

Operations of the shift register 300 having the aforementioned constitution are described with reference to the timing diagrams of FIGS. 4 and 5.

In a non-active period, because each stage is in a state where the first output terminal and the third output terminal Y and OUT have a low level, the second output terminal OUTB has a high level, the first input terminal IN has a low level, and the second input terminal INB has a high level, the second node N2 maintains a low state, and the first node N1 maintains a high state by the latch part 324. At this time, the control signal CTL maintains a low state. Accordingly, the first and second PMOS transistors PM1 and PM2, and the first and second NMOS transistors NM1 and NM2 all maintain an off-state. Thus, the output maintains a signal state latched by the latch part 324 regardless of the clock signal applied to the clock terminal CK and the inverted clock terminal CKB.

As the level of the first input terminal IN is changed into a high state, and the level of the second input terminal INB is changed into a low state, the control signal CTL is changed into a high state. Thus, the first PMOS transistor PM1, the first NMOS transistor NM1, and the second NMOS transistor NM2 of the level shift part 322 are turned on. Accordingly, a voltage by a voltage division due to a turn on resistance ratio of the first PMOS transistor PM1 and the first NMOS transistor NM1 as turned on is detected from the first node N1.

As shown in FIG. 5, a voltage of the first node N1 is dropped from 9.3V to approximately 7.2V by 3V applied to the clock terminal CK during a first half period of the clock signal.

However, because the second PMOS transistor PM2 maintains turn-off state and only the second NMOS transistor NM2 maintains turn-on state, the second node N2 still maintains 0 volt state by 0 volt applied to the inverted clock terminal CKB.

So, during the first half period of the clock signal, only a first steady current path is formed from the first power voltage terminal VDD to the second power voltage terminal VSS.

Under the above state, as the phase of the clock signal is inverted and a down transition of the voltage level of an input signal applied to the second input terminal INB occurs, the first PMOS transistor PM1 is turned on, so that the voltage of the first node N1 is abruptly dropped and output from 7.2V to 0V. At this time, because the second PMOS transistor PM2 is turned on, a voltage due to a turn-on resistance ratio of the second PMOS transistor PM2 and the second NMOS transistor NM2 is provided to the second node N2, so that the voltage level of the second node N2 rises from 0V to 7.2V.

So, the latch part 324 latches the states of the first and second nodes N1 and N2 in which the transition of the state has occurred.

The first output circuit 330 outputs the first output signal in a high state to the first output terminal Y in response to low state of the first node N1. The second output circuit 340 outputs the buffered second output signal in a high state in response to the high state of the second node N2, and outputs the third output signal in an inverted low state to the third output terminal OUTB.

Because the signal state of the first output terminal Y is in a state wherein the transition into a high state has occurred, even through a transition of the signal applied to the input terminal into a low state occurs, the control signal CTL still maintains a high state that is the previous state. However, because the state of the second input terminal INB is in a state wherein the state has been changed from low state to high state, PM1 maintains a turn-off state.

So, the first NMOS transistor NM1 maintains a turn-on state during next half period of the clock signal, but because PM1 and PM4 are turned off, the first steady current path is shut off, and only a second steady current path is formed from the first power voltage terminal VDD to the second power voltage terminal VSS.

If phase of the clock signal is inverted, the voltage level of the first node N1 rises from 0V to 7.2V, and the voltage level of the second node N2 is dropped from 7.2V to 1.2V. Accordingly, the output signals of the output terminals Y and OUT are transited (changed) from high level to low level, and the output signal of the output terminal OUTB is transited from low level to high level.

So, the control signal CTL is transited to low level, and accordingly all transistors of the level shift part 322 are turned off.

Accordingly, because the first node N1 continues to be charged by the turned-on fourth PMOS transistor PM4 of the latch part 324, the voltage level of the first node N1 rises to 9V, and because the second node N2 continues to be discharged by the turned-on third NMOS transistor NM3, the voltage level of the second node N2 is dropped to 0V.

As described previously, since in the shift register in accordance with one embodiment of the present invention, the first and second PMOS transistors PM1 and PM2 of the level shift part 322 maintain a turn-on state alternatively during the half period of the clock signal, only the first steady current path is formed during the first half period, and only the second steady current path is formed during the remaining half period. Also, the control signal maintains a swing width between 0V and 7.2V.

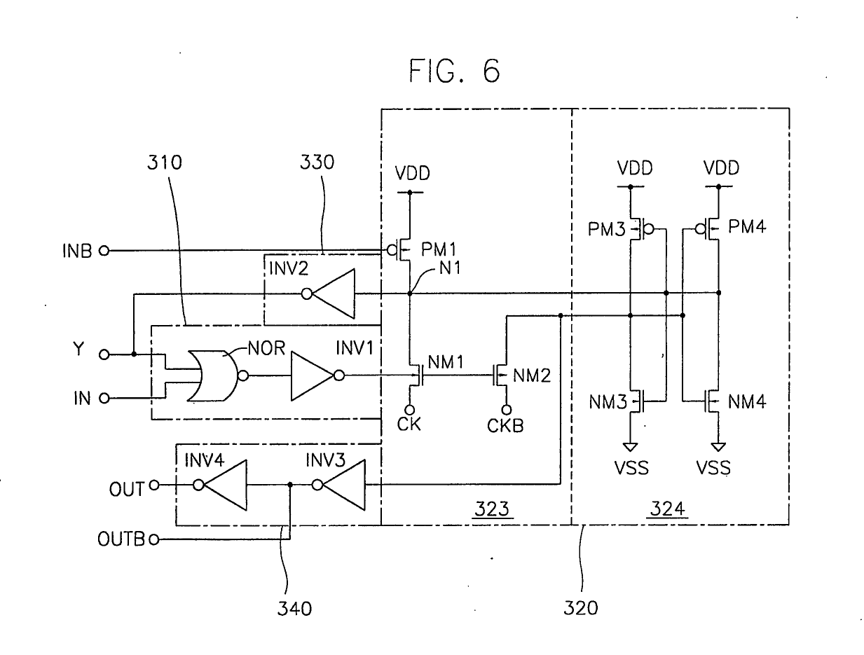

FIG. 6 is a circuit diagram of each of stages of the shift register in accordance with another embodiment of the present invention. In FIG. 6, the same elements as in those of the previous embodiment are denoted as the same reference numerals.

Compared with the previous embodiment, the present embodiment has a level shift part 323 in which the second PMOS transistor PM2 is removed from the constitution of the level shift part 322.

In the present embodiment, the third PMOS transistor PM3 of the latch part 323 is constituted to concurrently perform the role of the second PMOS transistor PM2. In other words, since the first and second PMOS transistors PM1 and PM2 of the level shift part have an ⅕ size of the first and second NMOS transistors NM1 and NM2 but the third and fourth PMOS transistors PM3 and PM4 of the latch part has a 7-8 times size of the third and fourth PMOS transistors NM3 and NM4, although the level shift part 323 is constituted to allow the third PMOS transistor PM3 to concurrently perform the role of the second PMOS transistor PM2 without the second PMOS transistor PM2, it is possible to maintain a current driving capability capable of sufficiently charging the second node N2.

Since the remaining operations of the present embodiment are the same as in those of the previous embodiment, the detailed description thereof is intentionally omitted.

Meanwhile, for the comparison, the constitution of the aforementioned shift register is partially changed in the following embodiments.

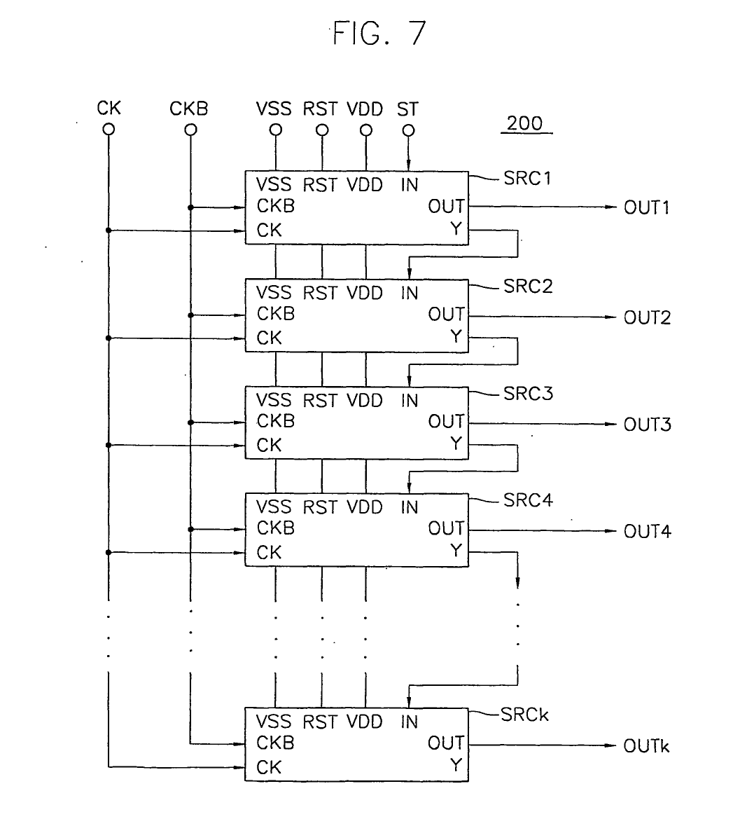

FIGS. 7 to 10 show shift registers of comparative examples.

Referring to FIG. 7, like the previous embodiments, a shift register includes multiple stages SRC1-SRCk connected in a cascade fashion.

Each stage includes an input terminal IN, a clock terminal CK, an inverted clock terminal CKB, a first power voltage terminal VDD, a second power voltage terminal VSS, a first output terminal Y, a second output terminal OUTB, and a reset terminal RST.

The stages SRC1-SRCk are connected in a cascade fashion in which the first output terminal Y of (i−1)-th stage SRC(i−1) is connected to the input terminal IN of i-th stage SRCi, and the first output terminal Y of (i)-th stage SRCi is connected to the input terminal IN of (I+1)-th stage SRC(i+1). Start signal ST is connected to the input terminal IN of the first stage SRC1.

A pulse signal output from the second output terminal OUT of each stage is provided as the scan pulse signal.

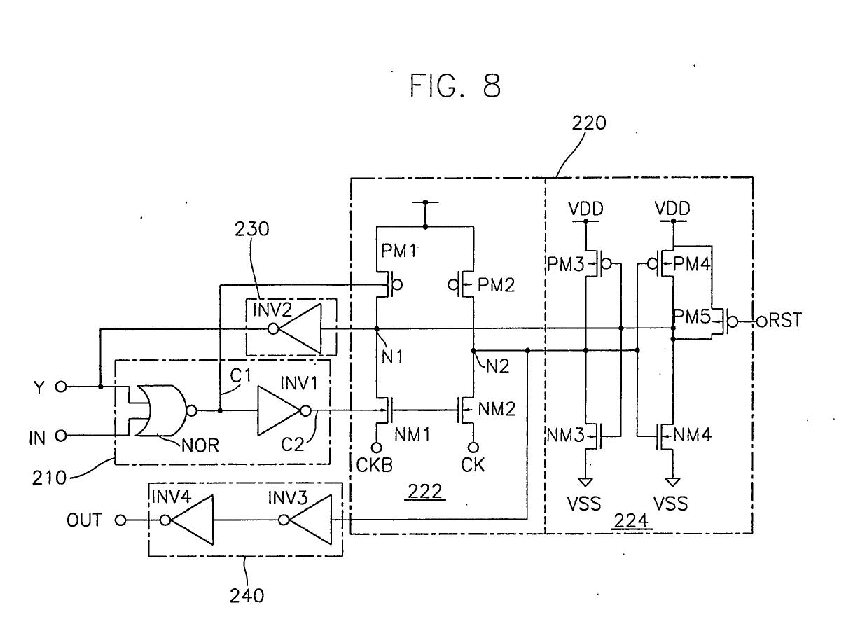

Referring to FIG. 8, as a comparative example, each stage of the shift register 200 includes an input circuit 210, a level shifter 220, a first output circuit 230, and a second output circuit 240.

The input circuit 210 includes an NOR gate for combining signals provided from an input terminal IN and a first output terminal Y thereof to generate a first control signal, and an inverter INV1 for inverting the first control signal to output a second control signal.

The level shifter 220 includes a level shift part 222 and a latch part 224.

The level shift part 222 includes first and second PMOS transistors PM1 and PM2, and first and second NMOS transistors NM1 and NM2.

The first PMOS transistor PM1 has a source connected to a first power voltage terminal VDD, a drain connected to a first node N1, and a gate that receives the first control signal C1. The first NMOS transistor NM1 has a drain connected to the first node N1, a source connected to a clock terminal CK, and a gate that receives the second control signal C2.

The second PMOS transistor PM2 has a source connected to the first power voltage terminal VDD, a drain connected to a second node N2, and a gate that receives the first control signal C1. The second NMOS transistor NM2 has a drain connected to the second node N2, a source connected to an inverted clock terminal CKB, and a gate that receives the second control signal C2.

The latch part 224 includes third to fifth PMOS transistors PM3 to PM5, and third and fourth NMOS transistors NM3 and NM4.

The third PMOS transistor PM3 has a source connected to the first power voltage terminal VDD, a drain connected to the second node N2, and a gate connected to the first node N1. The third NMOS transistor NM3 has a drain connected to the second node N2, a source connected to the second power voltage terminal VSS, and a gate connected to the first node N1.

The fourth PMOS transistor PM4 has a source connected to the first power voltage terminal VDD, a drain connected to the first node N1, and a gate connected to the second node N2. The fourth NMOS transistor NM4 has a drain connected to the first node N1, a source connected to the second power voltage terminal VSS, and a gate connected to the second node N2.

The fifth PMOS transistor PM5 has a source connected to the first power voltage terminal VDD, a drain connected to the first node N1, and a gate connected to the reset terminal RST.

The first output circuit 230 inverts the signal of the first node N1 through the inverter INV2 and outputs the inverted signal to the first output terminal Y.

The second output circuit 240 includes inverters INV3 and INV4 connected in cascade fashion, and it buffers the signal of the second node N2 to output the buffered signal to the second output terminal OUT.

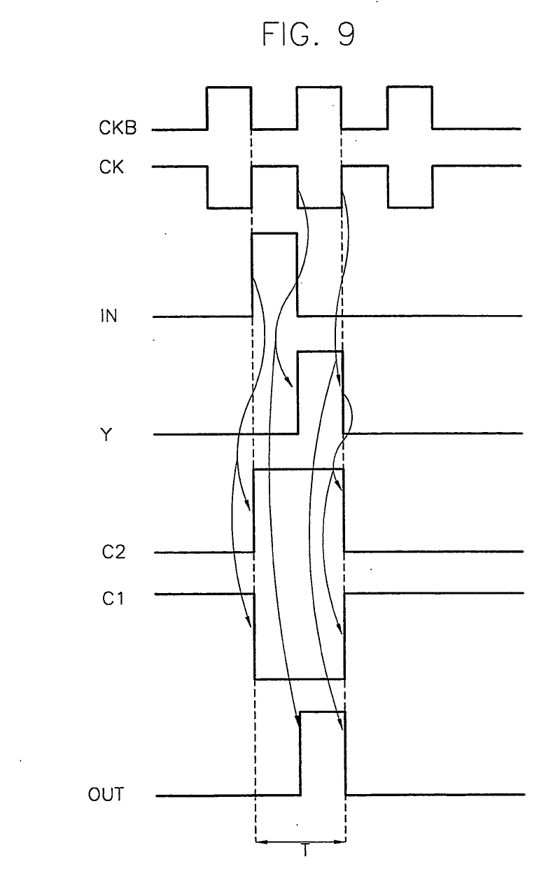

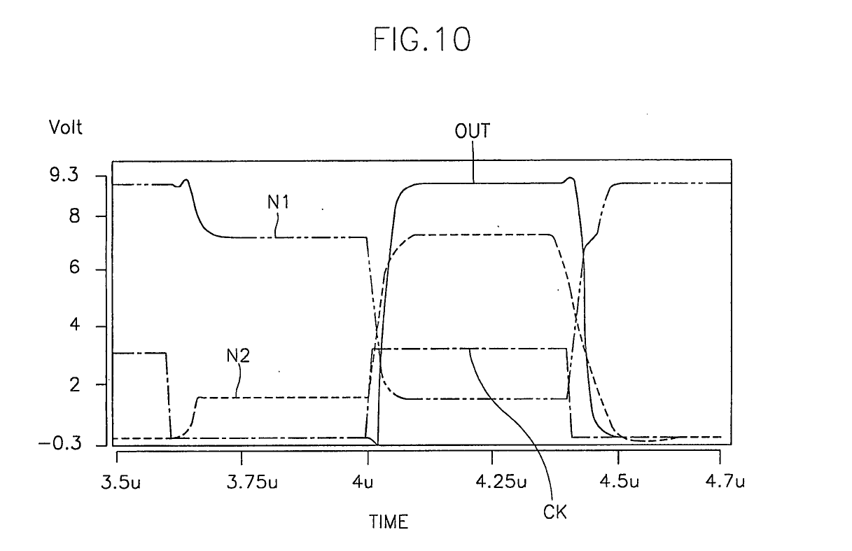

Operations of the conventional shift register 200 having the aforementioned constitution are described with reference to the timing diagrams of FIGS. 9 and 10.

In a non-active period, because each stage is in a state that the first output terminal Y and the second output terminal OUT have a low level, the second node N2 maintains a low state and the first node N1 maintains a high state by the latch part 224. The first control signal C1 maintains a high state and the second control signal C2 maintains a low state. Accordingly, all of the first and second PMOS transistors PM1 and PM2 and the first and second NMOS transistors NM1 and NM2 maintain an off state. Thus, regardless of clock signals applied to the clock terminal CK and the inverted clock terminal CKB, the output state is maintained at a state latched by the latch part 224.

As the level of the input terminal IN is transited to a high state, the first control signal C1 is transited to a low state, and the second control signal C2 is transited to a high state. Thus, all the registers of the level shift part 22 are turned on.

As shown in FIG. 10, the first node N1 is voltage-dropped from 9.3V to approximately 7.2V by 3V applied to the clock terminal CK during a first half period of the clock signal, and a level of the second node N2 rises from 0V to approximately 1.2V by 0V applied to the inverted clock terminal CKB.

Therefore, a first steady current path is formed from the first power voltage terminal VDD to the second power voltage terminal VSS, and a second steady current path is formed from the first power voltage terminal VDD to the second power voltage terminal VSS.

Under the above state, when the phase of the clock signal is inverted, the voltage level of the first node N1 is dropped from 7.2V to 1.2V and the voltage level of the second node N2 rises from 1.2V to 7.2V, as shown in FIG. 10.

So, the latch part 224 latches the states of the first and second nodes N1 and N2 which state is transited The first output circuit 230 outputs the first output signal in a high state to the first output terminal Y in response to low state of the first node N1. The second output circuit 240 outputs the buffered second output signal in a high state to the second output terminal OUT in response to the high state of the second node N2.

Because the signal state of the first output terminal Y is in a state which has been transited to a high state, even through a signal applied to the input terminal is transited to a low state, the first and second control signals C1 and C2 still maintains the previous state.

Therefore, during a next half period of the clock signal, the first steady current path is maintained from the first power voltage terminal to the second power voltage terminal VSS through the first PMOS transistor PM1 and the second NMOS transistor NM1, and the second steady current path is maintained from the first power voltage terminal VDD to the second power voltage terminal VSS through the second and second PMOS transistors PM2 and PM3, and the second NMOS transistor NM2.

If the phase of the clock signal is inverted, the voltage level of the first node N1 rises from 1.2V to 7.2V, and the voltage level of the second node N2 is dropped from 7.2V to 1.2V. Accordingly, the output signals of the output terminals Y and OUT are transited from a high level to a low level.

So, both the first and second control signals C1 and C2 are transited to a low level, and accordingly all transistors of the level shift part 222 are turned off.

Accordingly, because the first node N1 continues to be charged by the turn-on state of the fourth PMOS transistor PM4 of the latch part 224, the voltage level of the first node N1 rises to 9V, and since the second node N2 continues to be discharged by the turn-on state of NM3, the voltage level of the second node N2 is dropped to 0V.

As described above, in the shift register in accordance with the comparative example, all transistors of the level shift part 222 maintain a turn-on state during one period of the clock signal.

In other words, as shown in FIG. 10, power is continuously consumed during one period of the clock signal by the steady current. In contrast, in the embodiments of the present invention, the first and second steady currents maintain turn-on state and turn-off state alternatively.

Therefore, as shown in FIG. 5, when compared with the shift register of the comparative example in which all the first and second steady current paths are formed during one period of the clock signal, the shift register of the present invention shows a decrease by a half in the power consumption.

Also, as shown in FIG. 10, the shift register of the comparative example shows a difference of approximately 6V between 1.2V and 7.2V in the swing width, while the shift register of the embodiments of the present invention shows a larger difference of approximately 7.2V between 0V and 7.2V in the swing width, which results in the enhancement of 20% in a signal margin of the level-shifted pulse signal.

Further, since the shift register shown in the second embodiment of the present invention enables to decrease the number of the transistors by one, it has an advantage in that the design of the layout becomes easier and the design area is decreased.

### Industrial Applicability

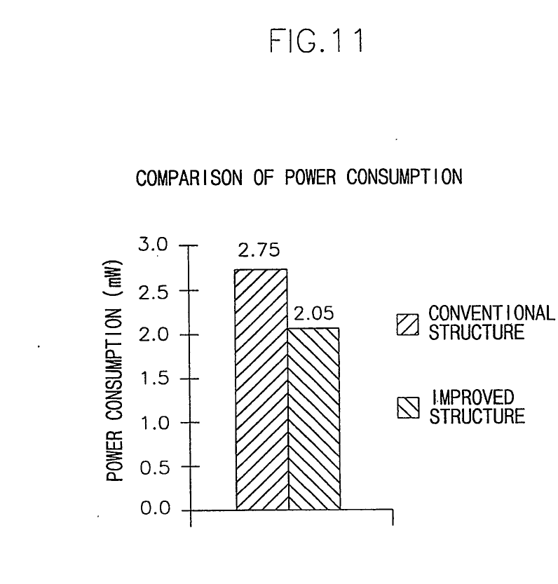

As described previously, by improving the circuit of the level shift part, the shift register of the present invention decreases the steady current to approximately ½, and as shown in FIG. 11, decreases the power consumption by approximately 30% from 2.75 mW to 2.05 mW compared with the shift register of the comparative example.

This invention has been described above with reference to the aforementioned embodiments. It is evident, however, that many alternative modifications and variations will be apparent to those having skills in the art in light of the foregoing description. Accordingly, the present invention embraces all such alternative modifications and variations as fall within the scope of the appended claims.

1. A shift register in which multiple stages are connected in a cascade fashion, each of the stages including a first input terminal IN, a second input terminal INB, a first output terminal Y, a second output terminal OUTB, a third output terminal OUT, a clock input terminal CK, and an inverted clock input terminal CKB,
each of the multiple stages SG(n) comprising:
an input means for combining a first output signal S(Yn−1) supplied from the first output terminal Y(n−1) of a previous stage SG(n−1) to the first input terminal IN and a first output signal S(Y) of the input means to generate a control signal CTL;
a level shift means for respectively generating a first pulse signal S(N1) which shifts a level of an inverted clock signal S(CKB) supplied to the inverted clock terminal CKB in response to the control signal CTL of the input means and a second output signal S(OUTB) supplied from the second output terminal OUTB of the previous stage SG(n−1), and a second pulse signal S(N2) which shifts a level of a clock signal S(CK) supplied to the clock input terminal CK in response to the control signal CTL of the input means and the first pulse signal S(N1); and
an output means for inverting a phase of the first pulse signal S(N1) and outputting the phase-inverted first pulse signal to the first output terminal Y coupled to the first input terminal IN+1 of a next stage SG(n+1) as the first output signal S(Y), inverting a phase of the second pulse signal S(N2) to output the phase-inverted second pulse signal SB(N2) to the second output terminal OUTB coupled to the second input terminal INB of the next stage SG(n+1) as the second output signal S(OUTB), and buffering the second pulse signal S(N2) and outputting the buffered second pulse signal to the third output terminal OUT as a third output signal S(OUT).

2. The shift register of claim 1, wherein the level shift means comprises:
a first PMOS transistor of which source is connected to a first power terminal, drain is connected to a first node, and gate is connected to the second input terminal;
a first NMOS transistor of which drain is connected to the first node, source is connected to the inverted clock input terminal, and gate receives the control signal;
a second PMOS transistor of which source is connected to the first power terminal, drain is connected to a second node, and gate receives the first pulse signal;
a second NMOS transistor of which drain is connected to the second node, source is connected to the clock input terminal, and gate receives the control signal;
a third PMOS transistor of which source is connected to the first power terminal, drain is connected to the second node, and gate is connected to the first node;
a third NMOS transistor of which drain is connected to the second node, source is connected to a second power terminal, and gate is connected to the first node;
a fourth PMOS transistor of which source is connected to the first power terminal, drain is connected to the first node, and gate is connected to the second node; and
a fourth NMOS transistor of which drain is connected to the second node, source is connected to the second power terminal, and gate is connected to the first node.

3. The shift register of claim 2, wherein the first and second NMOS transistors and the third and fourth PMOS transistors are larger than the first and second PMOS transistors and the third and fourth NMOS transistors.

4. The shift register of claim 3, wherein the level shift means comprises:
a first PMOS transistor of which source is connected to a first power terminal, drain is connected to a first node, and gate is connected to the second input terminal;
a first NMOS transistor of which drain is connected to the first node, source is connected to the inverted clock input terminal, and gate receives the control signal;
a second NMOS transistor of which drain is connected to a second node, source is connected to the clock input terminal, and gate receives the control signal;
a second PMOS transistor of which source is connected to the first power terminal, drain is connected to the second node, and gate is connected to the first node;
a third NMOS transistor of which drain is connected to the second node, source is connected to a second power terminal, and gate is connected to the first node;
a third PMOS transistor of which source is connected to the first power terminal, drain is connected to the first node, and gate is connected to the second node; and
a fourth NMOS transistor of which drain is connected to the second node, source is connected to the second power terminal, and gate is connected to the first node.

5. The shift register of claim 4, wherein the first and second NMOS transistors, and the third PMOS transistors are larger than the first and second PMOS transistors, and the third and fourth NMOS transistors.

6. A liquid crystal display including a display cell array circuit, a data driving circuit, and a gate driving circuit respectively formed on a transparent substrate, the display cell array circuit including multiple data lines and multiple gate lines, the respective display cell array circuits being connected to a pair of gate lines corresponding thereto,
at least either one of the data driving circuit or the gate driving circuit including a shift register generating a high voltage scan pulse signal synchronized with a low voltage clock signal,
the shift register in which multiple stages are connected one after another to each other including a first input terminal IN, a second input terminal INB, a first output terminal Y, a second output terminal OUTB, a third output terminal OUT, a clock input terminal CK, and an inverted clock input terminal CKB,
each of the multiple stages SG(n) comprising:
an input means for combining a first output signal S(Yn−1) supplied from the first output terminal Y(n−1) of a previous stage SG(n−1) to the first input terminal IN and a first output signal S(Y) of the input means to generate a control signal CTL;
a level shift means for respectively generating a first pulse signal S(N1) which shifts a level of an inverted clock signal S(CKB) supplied to the inverted clock terminal CKB in response to the control signal CTL of the input means and a second output signal S(OUTB) supplied from the second output terminal OUTB of the previous stage SG(n−1), and a second pulse signal S(N2) which shifts a level of a clock signal S(CK) supplied to the clock input terminal CK in response to the control signal CTL of the input means and the first pulse signal S(N1); and
an output means for inverting a phase of the first pulse signal S(N1) and outputting the phase-inverted first pulse signal to the first output terminal Y coupled to the first input terminal IN+1 of a next stage SG(n+1) as the first output signal S(Y), inverting a phase of the second pulse signal S(N2) to output the phase-inverted second pulse signal SB(N2) to the second output terminal OUTB coupled to the second input terminal INB of the next stage SG(n+1) as the second output signal S(OUTB), and buffering the second pulse signal S(N2) to output the buffered second pulse signal to the third output terminal OUT as a third output signal S(OUT).

7. The liquid crystal display of claim 6, wherein the level shift means comprises:
a first PMOS transistor of which source is connected to a first power terminal, drain is connected to a first node, and gate is connected to the second input terminal;
a first NMOS transistor of which drain is connected to the first node, source is connected to the inverted clock input terminal, and gate receives the control signal;
a second PMOS transistor of which source is connected to the first power terminal, drain is connected to a second node, and gate receives the first pulse signal;
a second NMOS transistor of which drain is connected to the second node, source is connected to the clock input terminal, and gate receives the control signal;
a third PMOS transistor of which source is connected to the first power terminal, drain is connected to the second node, and gate is connected to the first node;
a third NMOS transistor of which drain is connected to the second node, source is connected to a second power terminal, and gate is connected to the first node;
a fourth PMOS transistor of which source is connected to the first power terminal, drain is connected to the first node, and gate is connected to the second node; and
a fourth NMOS transistor of which drain is connected to the second node, source is connected to the second power terminal, and gate is connected to the first node.

8. The liquid crystal display of claim 7, wherein the first and second NMOS transistors, and the third PMOS transistors are larger than the first and second PMOS transistors, and the third and fourth NMOS transistors.

9. The liquid crystal display of claim 6, wherein the level shift means comprises:
a first PMOS transistor of which source is connected to a first power terminal, drain is connected to a first node, and gate is connected to the second input terminal;
a first NMOS transistor of which drain is connected to the first node, source is connected to the inverted clock input terminal, and gate receives the control signal;
a second NMOS transistor of which drain is connected to a second node, source is connected to the clock input terminal, and gate receives the control signal;
a second PMOS transistor of which source is connected to the first power terminal, drain is connected to the second node, and gate is connected to the first node;
a third NMOS transistor of which drain is connected to the second node, source is connected to a second power terminal, and gate is connected to the first node;
a third PMOS transistor of which source is connected to the first power terminal, drain is connected to the first node, and gate is connected to the second node; and
a fourth NMOS transistor of which drain is connected to the second node, source is connected to the second power terminal, and gate is connected to the first node.

10. The liquid crystal display of claim 9, wherein the first and second NMOS transistors, and the third PMOS transistors are larger than the first and second PMOS transistors, and the third and fourth NMOS transistors.

11. A shift register in which multiple stages are connected one after another to each other, of which first stage has an input terminal coupled to a start signal, the shift register sequentially outputting output signals of the respective stages, a control signal having an inverted phase from the start signal being input to a switching terminal of the first stage, a first clock signal and a second clock signal having an inverted phase from the first clock,
each of the multiple stages comprising:
a timing signal generating means for generating a timing signal of a corresponding stage in response to the start signal and an output signal of a previous stage;
a biasing means for receiving the first and second clock signals, biasing the first and second clock signals in response to the timing signal, and providing the first and second biased clock signals to first and second nodes as first and second output signals, respectively;
a first charging means being switched in response to the control signal and the first output signal, and providing the first power voltage to the second node;
a second charging means being switched in response to the first power voltage and the second output signal, and providing the first power voltage to the first node;
a first output means connected to the first node, for outputting the first output signal which is charged up to a predetermined voltage level by the second charging means through a first output terminal as the output signal, and for providing a signal having an inverted phase from the first output signal to a switching terminal of a next stage as the control signal; and
a second output means connected to the second node, for outputting the second output signal which is charged up to a predetermined voltage level by the first charging means through a second output terminal as the start signal to an input terminal of the next stage.

12. The shift register of claim 11, wherein the first charging means comprises:
a first PMOS transistor of which gate is connected to the switching terminal, drain is connected to the second node, and source is connected to the first power voltage; and
a second PMOS transistor of which gate is connected to the first node, drain is connected to the second node, and source is connected to the first power voltage.

13. The shift register of claim 12, wherein the second charging means comprises:
a third PMOS transistor of which gate is connected to the second node, drain is connected to the first node, and source is connected to the first power voltage; and
a fourth PMOS transistor of which gate is connected to the second node, drain is connected to the first node, and source is connected to the first power voltage.

14. The shift register of claim 13, wherein each of the plural stages further comprises:
a first NMOS transistor of which drain is connected to the first node commonly with the drain of the fourth PMOS transistor, gate is connected to the second node commonly with the gate of the fourth PMOS transistor, and source is connected to a ground, and which is turned on in response to an output signal of the first charging means to maintain a voltage level of the first output signal detected from the first node at a ground level; and
a second NMOS transistor of which drain is connected to the second node commonly with the drain of the second PMOS transistor, gate is connected to the first node commonly with the gate of the second PMOS transistor, and source is connected to the ground, and which is turned on in response to an output signal of the second charging means to maintain a voltage level of the second output signal detected from the second node at the ground level.

15. The shift register of claim 14, wherein the biasing means comprises:
a fifth NMOS transistor of which gate is connected to the timing signal generating means, drain is connected to the second node commonly with the drain of the first PMOS transistor, and gate receives the second clock signal as an input;
a sixth NMOS transistor of which gate is connected to the timing signal generating means commonly with the gate of the fifth NMOS transistor, drain is connected to the first node commonly with the drain of the third PMOS transistor, and gate receives the first clock signal as an input.

16. The shift register of claim 14, wherein the first output means comprises:
a first inverter of which input terminal is connected to the first node, for providing a phase inverted signal of the first output signal to the switching terminal as the control signal; and
a second inverter of which input terminal is connected to an output terminal of the first inverter, for outputting the control signal and the phase inverted signal supplied from the first inverter.

17. The shift register of claim 14, wherein the second output means is a third inverter of which input terminal is connected to the second node, for providing a phase inverted signal of the second output signal appearing at the second node to an input terminal of the next stage as the start signal.

18. The shift register of claim 11, wherein the first charging means comprises:
a fifth PMOS transistor of which gate is connected to the switching terminal, drain is connected to the second node, and source is connected to the first power voltage; and
a sixth PMOS transistor of which gate is connected to the first node, drain is connected to the second node, and source is connected to the first power voltage.

19. The shift register of claim 18, wherein the second charging means is a seventh PMOS transistor of which gate is connected to the second node commonly with the drain of the sixth PMOS transistor, drain is connected to the first node commonly with the gate of the sixth PMOS transistor, and source is connected to the first power voltage.

20. The shift register of claim 19, wherein each of the plural stages comprises:
a third NMOS transistor of which drain is connected to the first node commonly with the drain of the seventh PMOS transistor, gate is connected to the second node commonly with the gate of the seventh PMOS transistor, and source is connected to a ground, and which is turned on in response to an output signal of the first charging means to maintain a voltage level of the first output signal detected from the first node at a ground level; and
a fourth NMOS transistor of which drain is connected to the second node commonly with the drain of the sixth PMOS transistor, gate is connected to the first node commonly with the gate of the sixth PMOS transistor, and source is connected to the ground, and which is turned on in response to an output signal of the second charging means to maintain a voltage level of the second output signal detected from the second node at the ground level.
